(19) United States
(12) Patent Application Publication
(10) Pub. No.: US 2007/0073721 A1
(43) Pub. Date: Mar. 29, 2007

(54) Apparatus and method for serviced data profiling operations

(75) Inventors: Andrey Belyy, Sunnyvale, CA (US); Wu Cao, Redwood City, CA (US); Cheryl Leigh Ehlman, Pioneer, CA (US); Monfor Yee, San Francisco, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/394,472

(22) Filed: Mar. 31, 2006

Related U.S. Application Data
(60) Provisional application No. 60/720,159, filed on Sep. 23, 2005.

(51) Int. Cl. G06F 17/30

(52) U.S. Cl. 707/10

(57) ABSTRACT

A computer readable medium includes executable instructions to establish a mapping mechanism to facilitate access to profile data from a set of client applications. A client profiling task from a requesting client application of the set of client applications is processed to form processed data. The processed data is passed to the requesting client application.

### CROSS REFERENCE TO RELATED APPLICATIONS

This application claims the benefit of U.S. Provisional Application No. 60/720,159, entitled “Apparatus and Method for Service Oriented Data Profiling Operations,” filed on Sep. 23, 2005, the contents of which are hereby incorporated by reference in their entirety.

### BRIEF DESCRIPTION OF THE INVENTION

This invention relates generally to information processing. More particularly, this invention relates to establishing serviced data profiling operations.

### BACKGROUND OF THE INVENTION

Database profiling is the process of analyzing a database to determine its structure and internal relationships. Database profiling assesses such issues as the tables used, their keys and number of rows, the columns used and the number of rows with a value, relationships between tables, and columns copied or derived from other columns. Database Profiling can also include analysis of tables and columns used by different applications, how tables and columns are populated and changed, and the importance of different tables and columns. Database profiling is useful when planning and managing data conversion and data cleanup projects. In addition, database profiling can be an initial step in defining a data quality domain, which is used in data quality profiling.

In some respects, database profiling is analogous to data processing operations performed on a database. Database profiling operations are also analogous to operations performed during the process of migrating data from a source (e.g., a database) to a target (e.g., another database, a data mart or a data warehouse), which is sometimes referred to as Extract, Transform and Load, or the acronym ETL. Unlike database and ETL operations, database profiling is potentially applied to multiple varied data sources and therefore requires different processing techniques. For example, data profiling systems may store metadata related to the data attributes being processed instead of actual data.

Current data profiling systems provide rudimentary forms of data processing and characterization. In addition, existing tools are application-specific, resulting in a proliferation of tools. Accordingly, it would be desirable to provide improved data profiling techniques that address deficiencies associated with prior art approaches.

### SUMMARY OF THE INVENTION

The invention includes a computer readable medium comprising executable instructions to establish a mapping mechanism to facilitate access to profile data from a set of client applications. A client profiling task from a requesting client application of the set of client applications is processed to form processed data. The processed data is passed to the requesting client application.

The invention provides data profiling functionality that can be accessed by client applications via web services and/or a web server. Using this loosely coupled architecture, the data profiling needs of a range of software applications are supported. The invention facilitates implementation of a profiling client and the ability to share profiling functionality between multiple profiling client applications.

### BRIEF DESCRIPTION OF THE FIGURES

The invention is more fully appreciated in connection with the following detailed description taken in conjunction with the accompanying drawings, in which:

FIG. 1 illustrates a computer system configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION OF THE INVENTION

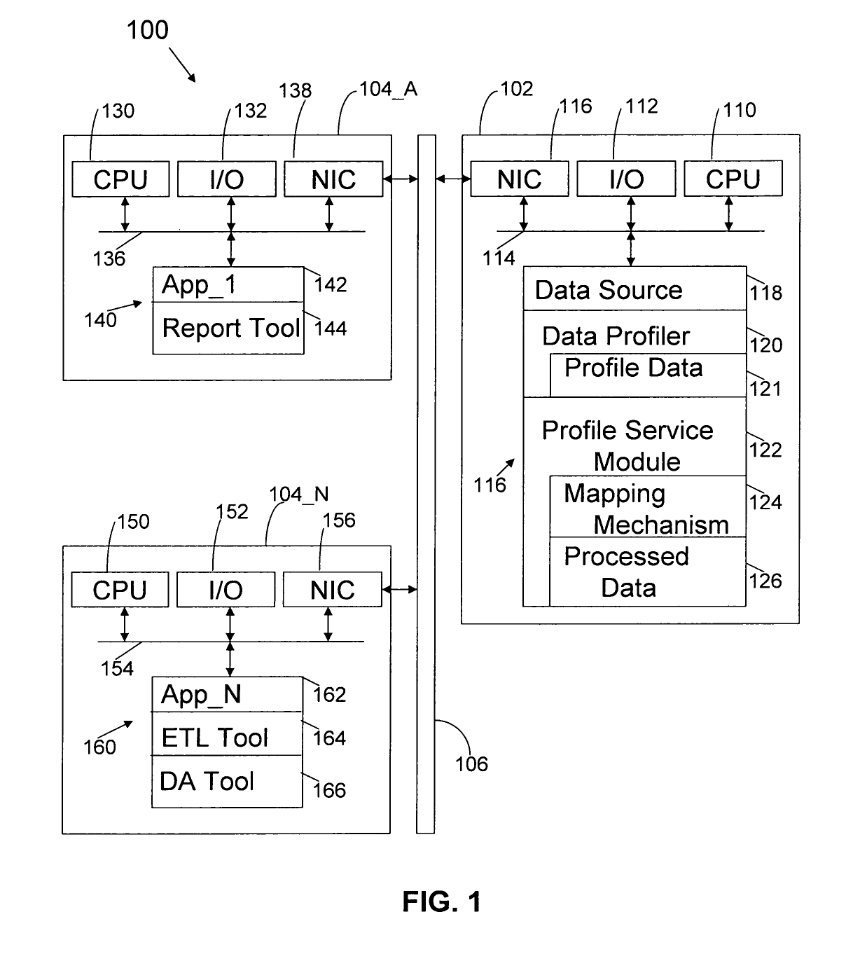

FIG. 1 illustrates a computer system 100 configured in accordance with an embodiment of the invention. The computer system 100 includes a server computer 102 connected to a set of client computers 104_A through 104_N through a transmission medium 106, which may be any wired or wireless transmission medium.

The server computer 102 includes standard components, such as central processing unit (CPU) 110 connected to a set of input/output devices 112 via a bus 114. The input/output devices 112 may include a keyboard, mouse, display, printer and the like. Also connected to the bus 114 is a network interface card (NIC) 116. The NIC 116 provides connectivity to the transmission medium 106 and the client computer 104_A through 104_N.

A memory 116 is also connected to the bus 114. The memory 116 includes a data source 118, such as a database. The memory also stores a data profiler 120, which operates on the data source 118 to produce profile data 121. The data profiler 120 includes executable instructions to perform data profiling operations. For example, the data profiling operations may include column property analyses to execute a set of rules on a single column. Structural analyses may also be performed, for example, analyzing primary keys, foreign keys, redundant columns and the like. Simple data analysis rules (e.g., a condition that must hold true across one or more columns) and complex data analysis rules (e.g., involving multiple objects) may also be performed as part of the data profiling operations. Value rule analyses, such as aggregation and statistics, may also be performed. The automatic generation of rules based upon profiling results may also be part of the data profiling operations. Embodiments of the invention may also include single column data profiling operations, such as identifying: a low value, a high value, a low value count, a high value count, an average value, a median value, a minimum string length, a maximum string length, an average string length, a median string length, a distinct count, a distinct percent, a null count, a null percent, a zero count, a zero percent, a blank count, a blank percent, pattern identification and a pattern count.

The memory 116 also stores a profile service module 122. The profile service module 122 includes executable instructions to implement operations of the invention. For example, the profile service module 122 includes executable instructions to facilitate access to profile data 121 from a set of client applications. In the prior art, a profile operation is performed for a single client application. Therefore, in the case of multiple client applications accessing a single data source, multiple data profiles must be created to service the multiple client applications.

The profile service module 122 includes a mapping mechanism 124 to overcome this shortcoming associated with the prior art. The mapping mechanism 124 allows profile data associated with a single data source to be accessed by a set of client applications. In order to share profile data across a set of different clients, the mapping mechanism 124 establishes a unique source identification for each client. In one embodiment, the unique source identification defines the implicit connection information of a source instance. The general form of the unique source identification may be defined by a system Application Program Interface (API) that includes the following format: Database::<Database Type>::<ServerName/Connection>::(<Database Name>). Thus, in the case of a SAP® system, the unique source identification may be: sap::<server name>::<system number>(::<R/3 Client number>?). In the case of a PeopleSoft® system, the unique source identification may be: PeopleSoft::<Database Type>::>::<ServerName/Connection>(::<Database Name>). In the case of a JDE™ system, the unique source identification may be: JDE::<Database Type>::>::<ServerName/Connection>(::<Database Name>). The case of a Siebel® system, the unique source identification may be: Siebe::<Database Type>::>::<ServerName/Connection>(::<Database Name>). In the case of an Oracle® system, the unique source identification may be: Oracle_Apps: Oracle_Apps::<Database Type>::<ServerName/Connection>(::<Database Name>). Thus, the mapping mechanism 124 may establish a look-up table linking a client request from a specific application to a single set of profile information. As a result, a single set of profile data 121 is utilized by a variety of client applications, obviating the need to execute a separate profile operation for each client application.

The profile service module 122 utilizes the mapping mechanism 124 to service requests from client computers 104_A through 104_N. The profile service module 122 services the requests to produce processed data 126, which is passed back to the client computers 104_A through 104_N. The processed data 126 may be the profile data 121 or a sub-set of the profile data 121, as specified by the client request.

The client computers 104_A through 104_N include standard components. For example, claim computer 104_A includes a CPU 130 that communicates with a set of input/output devices 132 over a bus 136. A network interface card (NIC) 138 is also attached to the bus 136 and provides connectivity to the transmission medium 106. A memory 140 stores a set of executable programs. In this example, memory 140 stores a first application 142, which includes executable instructions to access the profile data 121. Memory 140 also includes a standard reporting tool 144, which is operable to process the processed data 126 that it receives from the server 102.

The client computer 104_N also includes a CPU 150 connected to a set of input/output devices 152 via a bus 154. A network interface card (NIC) 156 is also connected to the bus 154. A memory 160 is also connected to the bus 154. In this example, the memory 160 stores application N 162. The memory 160 also stores various data analysis tools to operate on processed data 126 that is received in response to a request for profile data. The data analysis tools may include an ETL tool 164 and a data analysis tool 166. Thus, it can be appreciated that the profiling information returned in response to a request may be processed by a stack of tools (e.g., Report Tool 144, ETL Tool 164, and/or DA Tool 166).

Computer system 100 illustrates a client-server environment in which a set of clients executing different applications access a single set of profile data 121. In particular, each client request is processed by the mapping mechanism 124 of the profile server module 122 to link the request to the profile data 121. The profile service module 122 performs additional servicing operations to produce processed data 126, which is returned to the requesting client application.

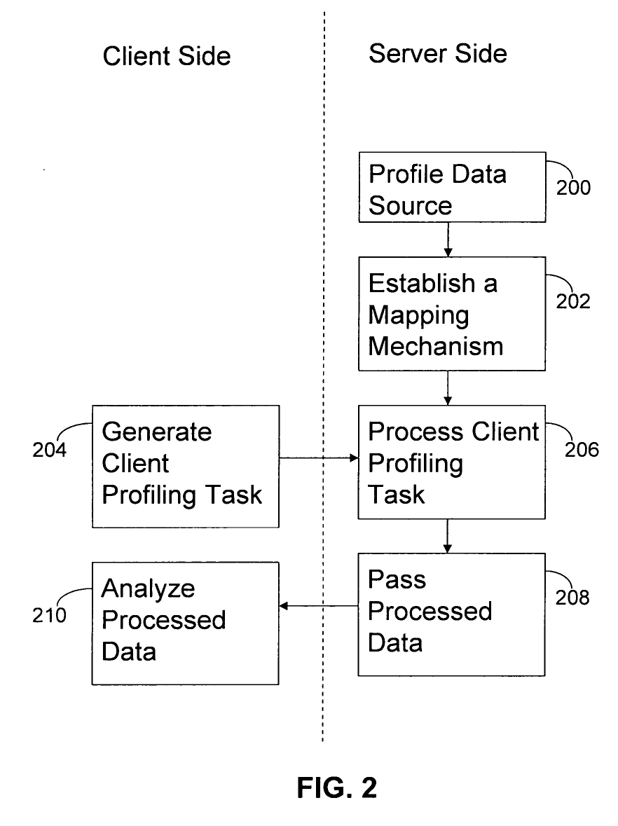

FIG. 2 illustrates processing operations associated with an embodiment of the invention. Operations are in FIG. 2 are shown as being either client side processing (on the left-hand side of the figure) or server side processing (on the right-hand side of the figure). Initially, a data source is profiled 200. The data profiler 120 may be used to implement this operation. A mapping mechanism is then established 202. The mapping mechanism 124 of the profile service module 122 may be used to map individual client requests to a single set of profile data using the schema described above. A client profile task is then generated on the client side 204. The client profiling task may be a request for a complete set of profile data or a sub-set thereof. The client profiling task is then processed 206 on the server side. The processed data is then passed back to the client 208. The processed data is then analyzed on the client side 210, for example, using one or more tools within a stack of tools.

The profile service module 122 is configured to support any number of client function calls. In one embodiment, the profile service module 122 is configured as a web service supporting a variety of services, such as login/logout services, administrative services, and inquiry/response (I/R) services.

The profile service module 122 may be configured to support a logon operation. In particular, in response to a client logon request, the profile service module 122 may return a session ID, which is included in by the client during subsequent client requests. A logout operation is also supported in one embodiment of the invention. The logout operation facilitates an exit from the profile service module 122 after a profile operation is completed for a client.

In one embodiment of the invention, after logging into the profile service module 122, a client may call a “Get_Task_By_Name” function. The profile service module 122 responds to this function call by retrieving the previous profiling information for a task based on the task name. If a task with the same name exists in the profiling repository, this call results in the return of the appropriate profiling information. The function call may include what table to profile, what profiling type to profile for each column (e.g., detail and simple), and the like. The client can then display the profiling information. The user is also allowed to modify the profiling information, for example, by adding a table, changing the profiling type of a column, etc.

After a user has defined the profiling information for a task, a client may call “Submit_profiling_task” to submit a task. In one embodiment, the profile service module 122 also supports a “Wait_Profiling_Task” function call, which establishes a wait state for a task to be completed after a task is submitted. The profile service module 122 may also support a “Get_Profiling_Task_List” function call, which periodically updates the status of each task. An embodiment of the invention also supports a “Cancel_Profiling_Task” function call to cancel a task that has been submitted to the profile service module 122.

After a task is completed, a client may invoke a “Get_Profiling_Summary” function to retrieve the profiling results (e.g., processed data 126). The profile service module 122 may also be configured to support drill down operations. For example, the profile service module 122 may be configured to support a “Get_Profiling_Data” function call, which results in supplying the client with sample data for a profiling attribute. The profile service module 122 may also supply a “Profiling_Job_Completed” task to notify a client when a profiling task is completed.

The profile service module 122 may be configured to concurrently process profile tasks. For example, requests may be divided into sub-requests for a data source (e.g., a table). A sub-request can be initiated if no other sub-request is being processed. For single table requests, a number of job queues, up to a configurable value (e.g., MaxConcurrentTableTask) may be used. Sub-requests may be inserted into queues using either a hash number of a table name or by random assignment If randomly assigned, one must ensure that the same tables are inserted into the same queue. If a sub-request is at the top of a queue, it may be executed.

In an embodiment of the invention, the profile service module 122 supports a number of configurable parameters, such as SAMPLING_SIZE (number of rows to be profiled), REFRESH_INTERVAL (number of minutes between refresh operations), CACHE_SIZE (number of rows saved for each attribute), VIEWDATA_SIZE (number of rows for view data), MAX_PROCESSES (maximum number of concurrent processes), MAX_CONCURRENT_TASKS, MAX_CONCURRENT_TABLES, MAX_CONCURRENT_COLUMNS, and the like.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
establish a mapping mechanism to facilitate access to profile data from a plurality of client applications;
process a client profiling task from a requesting client application of the plurality of client applications to form processed data; and
pass the processed data to the requesting client application.

2. The computer readable medium of claim 1 wherein the executable instructions to establish a mapping mechanism include executable instructions to define a unique source identification for each client application of the plurality of client applications.

3. The computer readable medium of claim 1 wherein each unique source identification specifies a database type.

4. The computer readable medium of claim 1 wherein each unique source identification specifies a server name connection.

5. The computer readable medium of claim 1 wherein each unique source identification specifies a database name.

6. The computer readable medium of claim 1 wherein the executable instructions to process a client profiling task include executable instructions to service a function call.

7. The computer readable medium of claim 6 wherein the executable instructions to service a function call include executable instructions to service a function call through an application program interface.

8. The computer readable medium of claim 6 wherein the executable instructions to service a function call include executable instructions to process a logon request.

9. The computer readable medium of claim 6 wherein the executable instructions to service a function call include executable instructions to process a logout request.

10. The computer readable medium of claim 6 wherein the executable instructions to service a function call include executable instructions to process a task name.

11. The computer readable medium of claim 6 wherein the executable instructions to service a function call include executable instructions to process a profile task wait command.

12. The computer readable medium of claim 6 wherein the executable instructions to service a function call include executable instructions to process a profile task status request.

13. The computer readable medium of claim 6 wherein the executable instructions to service a function call include executable instructions to process a profile task cancel command.

14. The computer readable medium of claim 6 wherein the executable instructions to service a function call include executable instructions to process a profile task summary command.

15. The computer readable medium of claim 1 wherein the executable instructions to pass processed data include executable instructions to pass a profile attribute.

16. The computer readable medium of claim 1 wherein the executable instructions to pass processed data include executable instructions to pass a profile task completed notification.

17. The computer readable medium of claim 1 further comprising executable instructions to facilitate a data analysis upon the processed data.

18. The computer readable medium of claim 1 further comprising executable instructions to facilitate a reporting operation on the processed data.

19. The computer readable medium of claim 1 further comprising executable instructions to facilitate an extraction, transform and load operation on the processed data.

20. The computer readable medium of claim 1 further comprising executable instructions to facilitate a data assessment task on the processed data.
